(19) United States
(12) Patent Application Publication
(10) Pub. No.: US 2025/0253072 A1
(43) Pub. Date: Aug. 7, 2025

(54) SYSTEM FOR AND METHOD OF MANUFACTURING A FLEXIBLE FLAT CABLE

(71) Applicant: Manaflex, LLC, Waikoloa, HI (US)

(72) Inventors: Robert C. LANE, Las Vegas, NV (US); Augusto E. BARTON, Pinecrest, FL (US); Yifei LIU, Toronto (CA)

(21) Appl. No.: 19/044,760

(22) Filed: Feb. 4, 2025

Related U.S. Application Data
(60) Provisional application No. 63/549,615, filed on Feb. 5, 2024.

(51) Int. Cl. H01B 13/00; H01B 1/02; H01B 7/02; H01B 7/08

(52) U.S. Cl. CPC H01B 13/0036; H01B 1/02; H01B 7/0208; H01B 7/0807; H01B 13/0013

(57) ABSTRACT

A reel-to-reel flex circuit manufacturing process can be used to manufacture an FFC or flex circuit products. The processes use a laser ablation technique to generate layer patterns. The reel-to-reel process can be performed to manufacture flexible flat cables that have conductive traces that have different widths and that also have openings, such as pads, at desired locations.

### CROSS-REFERENCE TO RELATED APPLICATION

This application is a non-provisional application of, and claims priority to and the benefit of, U.S. Provisional Patent Application No. 63/549,615, entitled “SYSTEM FOR AND METHOD OF MANUFACTURING A FLEXIBLE FLAT CABLE,” filed Feb. 5, 2024, the entire disclosure of which is hereby incorporated by reference in its entirety.

### FIELD OF INVENTION

The present invention relates to a system for and method of manufacturing a flexible flat cable (FFC), and more particularly, to a method of manufacturing an FFC utilizing a reel-to-reel process.

### BACKGROUND

Conventional manufacturing processes for FFCs have several limitations and drawbacks. One drawback is that there are limitations on the dimensions of a trace that can be manufactured. In particular, the trace is limited in several dimensions, which may include its width, its length, and its thickness. Another drawback is that the trace has a limited current-carrying capacity, which is caused by the limitation on the width and the thickness of the trace. A yet another drawback is that a conventionally manufactured trace has a limited compatibility to be connected to connectors because of the spacing of traces and the thin traces.

An additional drawback is that a trace has space constraints because of a generally uniform trace width and length requirement in the industry. Also, conventional traces lack the flexibility to have openings, such as pads, for electrical connections in the middle of the cable. Another drawback is the waste of material, such as aluminum, that increases the cost of the finished product.

Thus, there is a need for a process for manufacturing an FFC that addresses the drawbacks identified above.

### SUMMARY

A reel-to-reel flex circuit manufacturing process can be used to manufacture an FFC or flex circuit products. The processes use a laser ablation technique to generate layer patterns. The reel-to-reel process can be performed to manufacture flexible flat cables that have conductive traces that have different widths and that also have openings, such as pads, at desired locations.

In one aspect of this disclosure, a method of manufacturing a flexible circuit comprises a method of manufacturing a flexible flat cable, the method comprising the steps of providing a first material; cutting the first material into a first trace and a second trace; splitting the first trace and the second trace; providing a second material, the second material being a cover layer; providing a third material, the third material being a cover layer; laminating both the second material and the third material to the first trace and the second trace to form a laminated product; and cutting the laminated product.

In one aspect of this disclosure, the first trace has a length and a width, and the width is variable along the length of the first trace.

In another aspect of this disclosure, the first material is aluminum.

In another aspect of this disclosure, the third material is the same as the second material.

In another aspect of this disclosure, each of the second material and the third material is polyethylene terephthalate (PET).

In another aspect of this disclosure, the first trace and the second trace have a top side and a bottom side opposite to the top side, the step of providing a second material includes positioning the second material proximate to the top side, and the step of providing a third material includes positioning the third material proximate to the bottom side.

In another aspect of this disclosure, the method further comprises the step of patterning the laminated product.

In another aspect of this disclosure, the laminated product has a top side and an opposite bottom side, the step of patterning the laminated product includes forming an opening in the laminated product top side, the opening being located proximate to one of the first trace or the second trace.

In another aspect of this disclosure, the method further comprises the steps of cutting the laminated product; and scanning the laminated product after it has been cut.

In another aspect of this disclosure, the step of splitting the first trace and the second trace includes splitting the first trace and the second trace apart using a pitch roller.

In a different aspect of this disclosure, a method of manufacturing a flexible flat cable or a flexible circuit comprises the steps of providing a first material; cutting the first material into a first trace and a second trace; splitting the first trace and the second trace; providing a second material proximate to the first trace and the second trace; providing a third material proximate to the first trace and the second trace; laminating both the second material and the third material to the first trace and the second trace to form a laminated product; and cutting the laminated product.

In one aspect of this disclosure, the first trace has a length and a width, and the width is variable along the length of the first trace.

In another aspect of this disclosure, the first material is aluminum, and each of the second material and the third material is polyethylene terephthalate.

In another aspect of this disclosure, the first trace and the second trace have a top side and a bottom side opposite to the top side, the step of providing a second material includes positioning the second material proximate to the top side, and the step of providing a third material includes positioning the third material proximate to the bottom side.

In another aspect of this disclosure, the laminated product has a top side and an opposite bottom side, and the method further comprises the step of patterning the laminated product by forming an opening in the laminated product top side, the opening being located proximate to one of the first trace or the second trace.

In another aspect of this disclosure, the step of splitting the first trace and the second trace includes splitting the first trace and the second trace apart using a pitch roller.

In a different aspect of this disclosure, a flexible flat cable comprises a first trace being formed from a first material, the first trace having a length and a variable width along its length; a second trace being formed from the first material, the second trace being split apart from the first trace; a first cover layer made of a second material, the first cover layer being laminated to a top side of the first trace and the second trace; and a second cover layer made of the second material, the second cover layer being laminated to a bottom side of the first trace and the second trace, wherein the first cover layer, the second cover layer, the first trace, and the second trace collectively form a laminated product.

In one aspect of this disclosure, the first material is aluminum, and the second material is polyethylene terephthalate.

In another aspect of this disclosure, the laminated product has a top side and an opposite bottom side, the top side of the laminated product has an opening formed therein.

In another aspect of this disclosure, the opening is proximate one of the first trace or the second trace.

### BRIEF DESCRIPTION OF THE DRAWINGS

To complete the description and in order to provide for a better understanding of the present application, a set of drawings is provided. The drawings form an integral part of the description and illustrate embodiments of the present application, which should not be interpreted as restricting the scope of the invention, but just as examples. The drawings comprise the following figures:

FIG. 1 illustrates a schematic drawing of an embodiment of a manufacturing system for an FFC according to an aspect of this disclosure.

FIG. 2 illustrates a schematic perspective drawing of an embodiment of an FFC according to an aspect of this disclosure.

FIG. 3 illustrates a schematic perspective drawing of another embodiment of an FFC according to an aspect of this disclosure.

FIG. 4 illustrates a top view of an embodiment of a pair of traces according to an aspect of this disclosure.

FIG. 5 illustrates a top view of another embodiment of a pair of traces according to an aspect of this disclosure.

FIG. 6 illustrates an exemplary method of manufacturing an FFC according to an aspect of this disclosure.

Like reference numerals have been used to identify like elements throughout this disclosure.

### DETAILED DESCRIPTION

The following description is not to be taken in a limiting sense but is given solely for the purpose of describing the broad principles of the invention. Embodiments of the invention will be described by way of example, with reference to the above-mentioned drawings showing elements and results according to the present invention.

In one aspect of the disclosure, the limitation on trace width and length in an FFC is overcome by the disclosed process. The steps of loading a roll of aluminum onto a reel, and then cutting the aluminum using a cutting device, such as a laser are included in the process. The cutting device can be used to cut the width of the aluminum as desired, whether at a constant width along the length of the trace or at a variable width along the length of trace, which enables different trace widths to be manufactured in a single FFC. Also, the same cutting device or a different one can be used to cut the length of the traces as desired. By being able to vary the width and length of traces, greater design flexibility for FFCs is achieved.

The limitation on current-carrying capacity in an FFC is overcome as well. By manufacturing traces that have different widths, some traces can be manufactured wider than others. The wider traces, which can carry a high current, can be used in a finished product for higher current rating requirements, and narrower traces can be used for lower current rating requirements. As a result, the restrictions on current-carrying capacity are addressed by being able to manufacture wider traces, and also variable width traces. Thus, wider traces can be used where high current is needed.

It is desirable for the product with traces to have the ability to have electrical connections. As mentioned above, the manufacturing process involves the removal of the insulator layer in certain areas to provide the ability to make electrical connections with traces. Thus, by being able to ablate the insulator layer anywhere along the trace, an electrical connection can be made anywhere along the cable with either laser welding or soldering to the conductor layer.

By improving the ability to make openings for electrical connections anywhere along the cable, different connections can be made along an FFC. Connections may be made by creating openings or pads along the traces. The openings on the traces may be laser welded or soldered. As a result, connector compatibility is not only limited to FFC connectors, and the overall compatibility to connectors is enhanced.

In one implementation according to the present disclosure, a method for the reel-to-reel production of FFC is described. In this process, a roll of aluminum with the desired width is loaded onto a reel. When the aluminum is unwound from the reel, the aluminum is cut precisely by a cutting device, such as a laser, into flat traces that have the desired widths (whether a constant width or a variable width). The flat traces can be referred to alternatively as conductive traces.

In different implementation, the process may include a slug removal process, or it may just rely on laser ablation. Either way, the flat cut traces are separated by a pitch roller to achieve the desired spacing.

After the cut traces are separated, a thermosetting PET is applied and laminated to top and bottom of the conductor traces serving as insulating and protective layer for the traces. In the areas where connections are required, laser ablation is used to remove the PET layer from top and bottom of the conductive traces, enabling exposure for electrical connections.

In some finished products, electrical connections to the flat traces are required. In areas where such electrical connections are required, the manufacturing process utilizes laser ablation to remove the PET layer from both of the top side and the bottom side of the conductive traces. As a result, the removed PET material in the particular area provides exposure and access to the conductive traces so electrical connections thereto can be made.

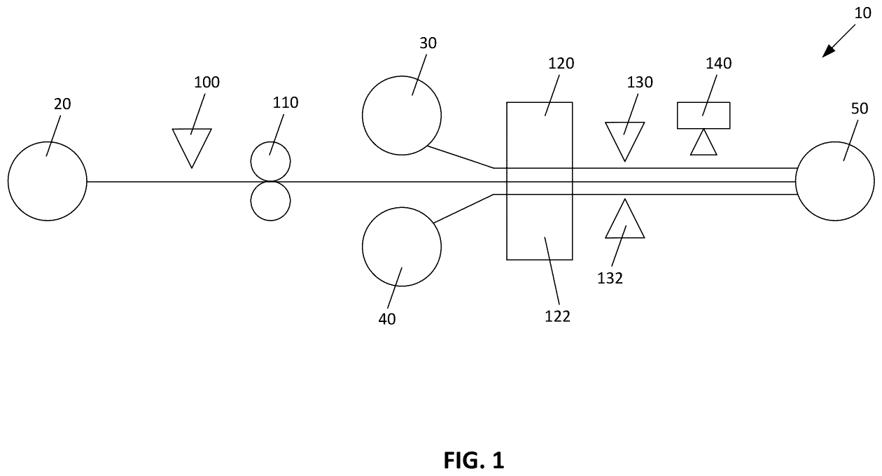

Turning initially to FIG. 1, an exemplary manufacturing system according to the present disclosure is illustrated. This manufacturing system is used to manufacture a flexible flat cable. In this embodiment, the manufacturing system 10 includes three sources of raw materials. One raw material is aluminum 20, which can be loaded onto a reel. The other two raw materials are PET, which can be loaded onto reels as well. The different materials are supplied continuously to the manufacturing system 10.

PET material 30 can be located on one side of the aluminum traces, such as the top side of the aluminum traces, and PET material 40 can be located on the opposite side of the aluminum traces, such as the bottom side of the aluminum traces. As described below, the PET are laminated to the traces on opposite sides thereof.

The system 10 includes a cutting device 100, such as a laser, that cuts the aluminum 20 into individual traces with either constant widths or variable widths. After the aluminum 20 is cut into individual traces, the cut traces are separated by one or more pitch rollers 110. The size and configuration of each pitch roller 110 can vary in different embodiments. In this embodiment, there is a pitch roller 110 located on an upper surface or side of the aluminum 20, and another pitch roller 110 located on a lower surface or side of the aluminum 20. In one embodiment, a drive mechanism, such as a motor with a gearbox, can be actuated to drive one or both of the pitch rollers 110. It is to be understood that in different embodiments, only one of the pitch rollers 110 may be actively drive, and the other of the pitch roller 110 is not.

The separated cut traces are moved or directed to lamination stations 120 and 122 in the system 10. PET roll 30 supplies a layer of PET material to a lamination station 120 where the PET material 30 is laminated on the top side or top surface of the cut traces. Simultaneously, PET roll 40 supplies a layer of PET material to another lamination station 122 where the PET material 40 is laminated on the bottom side or bottom surface of the cut traces. The resulting product exiting the lamination process at the lamination stations 120 and 122 is a laminated product with traces located between the PET material layers 30 and 40.

The laminated product is then transported to a position proximate to one or more cutting devices, such as lasers, that perform patterning of the PET material. In this embodiment, one cutting device 130 is located adjacent to the upper surface or side of the laminated product, and another cutting device 132 is located adjacent to the lower surface or side of the laminated product. Cutting devices 130 and 132 are used to cut the laminated product into multiple portions that have desired widths and lengths. In addition, the cutting devices 130 and 132 are used to ablate one or more particular areas to remove select amounts of PET material to form openings, which results in the aluminum layers or traces being exposed. After the ablating occurs, the cutting devices 130 and 132 are used to make any additional cuts to the laminated product so that the FFC pieces have the desired lengths.

In one implementation, the cut FFC products are then advanced to a scanner 140, such as a laser scanner, that performs a quality checking of the FFC product. The scanner 140 checks the shape of the FFC products and confirms that the openings in the FFC products are in their proper locations.

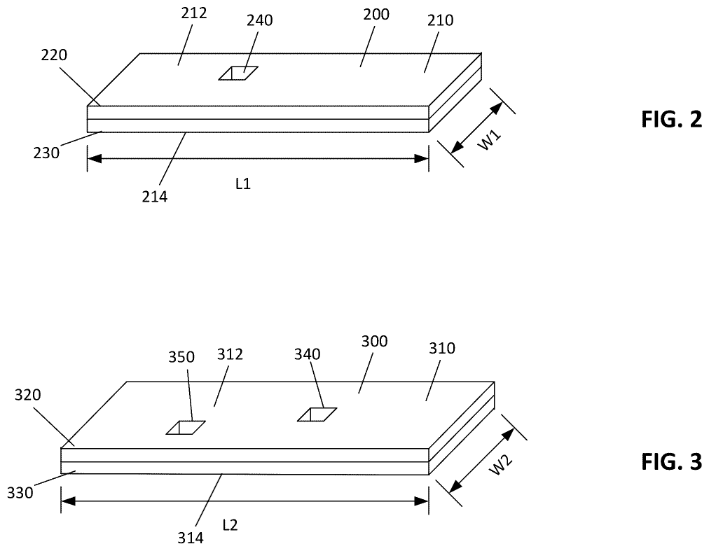

Referring to FIGS. 2 and 3, schematic perspective views of different embodiments of FFCs according to the present disclosure are illustrated. Turning initially to FIG. 2, the FFC product 200 includes a body 210 that is formed by PET material layers 220 and 230, which are laminated to opposite sides of the traces (not shown in FIG. 2). The body 210 has a top side or top surface 212 and an opposite bottom side or bottom surface 214. In this embodiment, the body 210, and in particular, the top side 212, has an opening 240 formed therein as a result of the patterning process briefly discussed above. There may be more than one opening 240 in the PET material layer 220, and there may be one or more openings formed in the lower surface of the FFC product 200 in the PET material layer 230. FFC product 200 has a width W1 and a length L1. In some embodiments, the width W1 may be constant along the length of the FFC product 200.

Turning initially to FIG. 3, the FFC product 300 includes a body 310 that is formed by PET material layers 320 and 330, which are laminated to opposite sides of the traces (not shown in FIG. 3). The body 310 has a top side or top surface 312 and an opposite bottom side or bottom surface 314. In this embodiment, the body 310, and in particular, the top side 312, has two openings 340 and 350 formed therein as a result of the patterning process briefly discussed above. There may be one or more openings formed in the lower surface of the FFC product 300 in the PET material layer 330. FFC product 300 has a width W2 and a length L2.

In some embodiments, the width W1 of FFC product 200 is different than the width W2 of FFC product 300. In various implementations, width W1 may be greater than or smaller than width W2. In other embodiments, the widths W1 and W2 may be same. Similarly, in some embodiments, the length L1 of FFC product 200 is different than the length L2 of FFC product 300. In various implementations, length L1 may be greater than or smaller than length L2. In other embodiments, the lengths L1 and L2 may be same.

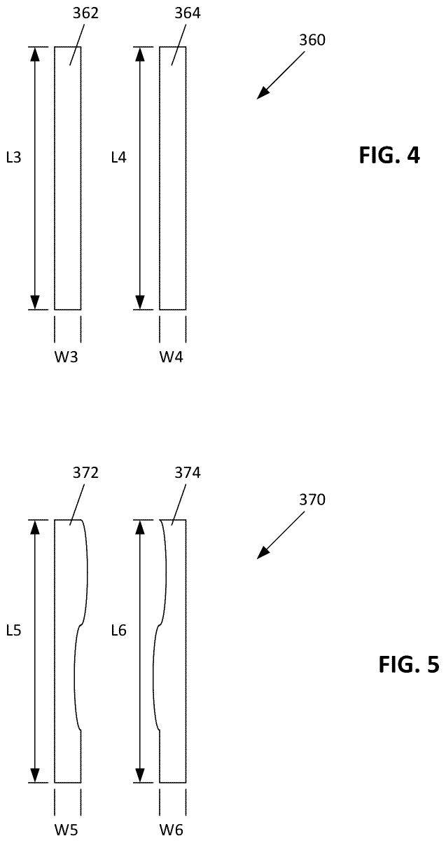

Turning to FIG. 4, an embodiment of a pair of traces according to an aspect of this disclosure is illustrated. In this embodiment, the pair 360 includes a first trace 362 and a second trace 364. The first trace 362 has a length L3 and a width W3, and the second trace 364 has a length L4 and a width W4. The width W3 of trace 362 is constant along the length L3. Similarly, the width W4 of trace 364 is constant along the length L4. It is to be understood that while two traces 362 and 364 are illustrated, the aluminum material can be split into more than two traces.

Turning to FIG. 5, another embodiment of a pair of traces according to an aspect of this disclosure is illustrated. In this embodiment, the pair 370 includes a first trace 372 and a second trace 374. The first trace 372 has a length L5 and a width W5, and the second trace 374 has a length L6 and a width W6. The width W5 of trace 372 varies along the length L5. Similarly, the width W6 of trace 374 varies along the length L6. It is to be understood that while two traces 372 and 374 are illustrated, the aluminum material can be split into more than two traces. Also, in different embodiments, the widths W5 and W6 as well as the shapes of the traces 372 and 374 can vary as desired.

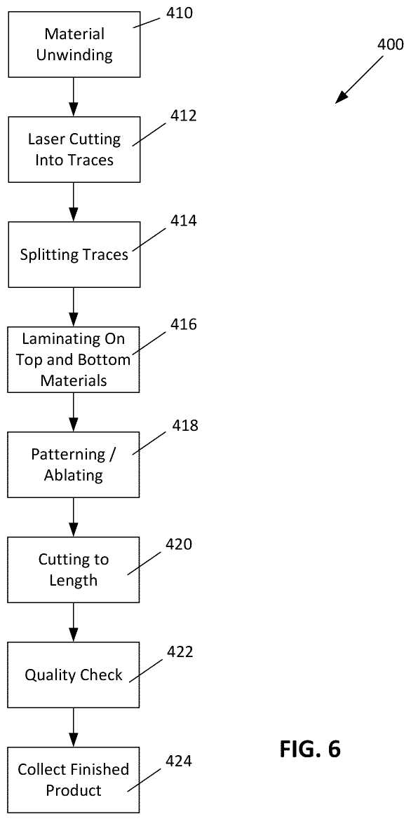

Referring to FIG. 6, an exemplary embodiment of a manufacturing process according to an aspect of the invention is illustrated. The process is used to manufacture an FFC.

In this embodiment, the manufacturing process 400 includes several steps, which are exemplary. The process 400 begins with step 410, which involves material unwinding. In one implementation, a large supply reel is loaded, and the reel contains a roll of aluminum and two rolls of PET. The PET rolls are located on opposite sides of the aluminum so that the PET rolls are located on opposite sides of the aluminum material for the lamination process. One of the PET rolls is positioned and directed to be adjacent to the bottom side of the aluminum material, and the other PET material roll is positioned and directed to be adjacent to the top side of the aluminum material. The aluminum material can be pulled off its reel and directed to a cutting device.

Turning to step 412, the step involves laser cutting of the aluminum material. The aluminum material that is taken off its roll and is cut into individual traces using a laser. The individual traces are cut to a desired width, which for a given trace length, can be either a constant width or a variable width.

After the cutting process in step 412, in step 414 the cut traces are split. In one embodiment, the cut traces are separated by a pitch roller into a certain pitch.

Turning to step 416, a laminating process is performed. Once the traces are split apart into their desired arrangement and configuration, the laminating process occurs. The aluminum traces pass through laminating stations to add the PET material layers to the top side and the bottom side of each trace. The PET material layers are protective and insulative layers located on the top side and the bottom side of each trace.

In step 418, a patterning process is performed on the laminated PET and trace materials. After the PET material has been laminated to the aluminum traces, the patterning process is performed. The laminated PET and aluminum material is cut into a desired width and a desired length. The PET material is then ablated at certain areas to expose the aluminum layer or trace and form openings or pads that are used for electrical connections to the traces.

Turning to step 420, after the PET material has been added and ablated, if applicable, the PET material is laser cut at a desired length.

In step 422, after that cutting is complete, the FFC passes through a laser scanner to check the shape of the board and the locations of the opening positions. The shape checking and the location checking is part of a quality check process.

The last step in this process 400 is step 424, in which the finished product is collected onto a reel.

The manufacturing processes disclosed herein have a reduction in waste of material as compared to rotary die laser cutting FPC processes. In the disclosed processes, aluminum is laser cut and separated instead of the conventional process of cutting and removing material at the trace pitch locations that are wasted.

In an alternative embodiment of the manufacturing process, the aluminum material can be replaced by any similar material, including, but not limited to, nickel-plated aluminum, nickel, or stainless steel. Similarly, the PET material can be replaced by alternative materials, including, but not limited to, polyimide (PI), polypropylene (PP), polyethylene naphthalate (PEN), and polyetherimide (PEI).

In another embodiment of the manufacturing process, the process of laser cutting traces into particular lengths could be replaced by performing a V-cut where the aluminum material is cut in depth but not completely separated. In one implementation, instead of a laser, mechanical cutting of the material using a blade or equivalent equipment can be performed.

Reference is made herein to relative locations of materials in terms of a “top side” or a “bottom side.” It is to be understood that while “top” or “bottom” are used to describe where a material is located, the alternative arrangement of “bottom” or “top” is also contemplated. Also, while the term “laser” is referenced, any suitable cutting device can be used to perform the referenced cutting and ablation, provided that the cutting device can properly and accurately make the desired cuts in one or more layers.

While the invention has been illustrated and described in detail and with reference to specific embodiments thereof, it is nevertheless not intended to be limited to the details shown, since it will be apparent that various modifications and structural changes may be made therein without departing from the scope of the inventions and within the scope and range of equivalents of the claims. In addition, various features from one of the embodiments may be incorporated into another of the embodiments. Accordingly, it is appropriate that the appended claims be construed broadly and in a manner consistent with the scope of the disclosure as set forth in the following claims.

Similarly, it is intended that the present invention cover the modifications and variations of this invention that come within the scope of the appended claims and their equivalents. For example, it is to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points of reference and do not limit the present invention to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment of the invention.

Finally, when used herein, the term “comprises” and its derivations (such as “comprising”, etc.) should not be understood in an excluding sense, that is, these terms should not be interpreted as excluding the possibility that what is described and defined may include further elements, steps, etc. Meanwhile, when used herein, the term “approximately” and terms of its family (such as “approximate,” etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about” and “around” and “substantially.

What is claimed is:

1. A method of manufacturing a flexible flat cable, the method comprising the steps of:
providing a first material;
cutting the first material into a first trace and a second trace;
splitting the first trace and the second trace;
providing a second material, the second material being a cover layer;
providing a third material, the third material being a cover layer;
laminating both the second material and the third material to the first trace and the second trace to form a laminated product; and
cutting the laminated product.

2. The method of claim 1, wherein the first trace has a length and a width, and the width is variable along the length of the first trace.

3. The method of claim 1, wherein the first material is aluminum.

4. The method of claim 1, wherein the third material is the same as the second material.

5. The method of claim 4, wherein each of the second material and the third material is polyethylene terephthalate (PET).

6. The method of claim 1, wherein the first trace and the second trace have a top side and a bottom side opposite to the top side, the step of providing a second material includes positioning the second material proximate to the top side, and the step of providing a third material includes positioning the third material proximate to the bottom side.

7. The method of claim 1, further comprising the step of:
patterning the laminated product.

8. The method of claim 7, wherein the laminated product has a top side and an opposite bottom side, the step of patterning the laminated product includes forming an opening in the laminated product top side, the opening being located proximate to one of the first trace or the second trace.

9. The method of claim 7, further comprising the steps of:
cutting the laminated product; and
scanning the laminated product after it has been cut.

10. The method of claim 9, wherein the step of splitting the first trace and the second trace includes splitting the first trace and the second trace apart using a pitch roller.

11. A method of manufacturing a flexible flat cable or a flexible circuit, the method comprising the steps of:
providing a first material;
cutting the first material into a first trace and a second trace;
splitting the first trace and the second trace;
providing a second material proximate to the first trace and the second trace;
providing a third material proximate to the first trace and the second trace;
laminating both the second material and the third material to the first trace and the second trace to form a laminated product; and
cutting the laminated product.

12. The method of claim 11, wherein the first trace has a length and a width, and the width is variable along the length of the first trace.

13. The method of claim 11, wherein the first material is aluminum, and each of the second material and the third material is polyethylene terephthalate.

14. The method of claim 11, wherein the first trace and the second trace have a top side and a bottom side opposite to the top side, the step of providing a second material includes positioning the second material proximate to the top side, and the step of providing a third material includes positioning the third material proximate to the bottom side.

15. The method of claim 11, wherein the laminated product has a top side and an opposite bottom side, and the method further comprises the step of:
patterning the laminated product by forming an opening in the laminated product top side, the opening being located proximate to one of the first trace or the second trace.

16. The method of claim 11, wherein the step of splitting the first trace and the second trace includes splitting the first trace and the second trace apart using a pitch roller.

17. A flexible flat cable, comprising:
a first trace being formed from a first material, the first trace having a length and a variable width along its length;
a second trace being formed from the first material, the second trace being split apart from the first trace;
a first cover layer made of a second material, the first cover layer being laminated to a top side of the first trace and the second trace; and
a second cover layer made of the second material, the second cover layer being laminated to a bottom side of the first trace and the second trace, wherein the first cover layer, the second cover layer, the first trace, and the second trace collectively form a laminated product.

18. The flexible flat cable of claim 17, wherein the first material is aluminum, and the second material is polyethylene terephthalate.

19. The flexible flat cable of claim 17, wherein the laminated product has a top side and an opposite bottom side, the top side of the laminated product has an opening formed therein.

20. The flexible flat cable of claim 19, wherein the opening is proximate one of the first trace or the second trace.
